(19) United States
(12) Patent Application Publication
(10) Pub. No.: US 2015/0278973 A1
(43) Pub. Date: Oct. 1, 2015

(54) METHOD AND APPARATUS FOR PROVIDING IMPROVED GENERATION OF HEALTHCARE MESSAGES

(71) Applicant: McKesson Financial Holdings, Hamilton (BM)

(72) Inventors: Bryan Self, Birmingham, AL (US); Brandon Wedgeworth, Alabaster, AL (US); Vincent Lee, Chelsea, AL (US)

(73) Assignee: McKesson Financial Holdings, Hamilton (BM)

(21) Appl. No.: 14/228,902

(22) Filed: Mar. 28, 2014

(51) Int. Cl. G06Q 50/22; G06F 17/22; H04L 29/08; G06Q 30/00

(52) U.S. Cl. CPC G06Q 50/22; G06Q 30/018; G06F 17/2247; H04L 67/02

(57) ABSTRACT

A method, apparatus and computer program product are provided in order to generate messages. An example method may include receiving a set of message script. The set of message script may include tokens defined within a message generation grammar. The message generation grammar may define a grammar for generating a standards-compliant message. The method may also include processing the set of message script, using a processor, wherein processing the set of message script comprises parsing and lexing the set of message script to select a set of message content. The method may also include generating a markup representation of the set of message script. The method may also include generating the standards-compliant message using the markup representation, wherein the content of one or more fields of the standards-compliant message is based at least in part on a corresponding tag of the markup representation.

Example embodiments of the present invention relate generally to healthcare messaging formats and, more particularly, to techniques for generating healthcare messages.

### BACKGROUND

As network technology has advanced, it is more and more common for common business functions to be performed by computers in communication with one another. However, different fields and industries often have different requirements for information transmission, security, data retention, and the like. As such, information systems in a given industry often communicate via particular formats unique to the use, business type, technological field, or the like within the industry. Over time, standards may be developed and adopted within the industry. One example standard that has emerged is the Health Level 7 (HL7) message format used in the clinical field. This messaging format is specially designed for sending and receiving information for the exchange, integration, sharing, and retrieval of clinical information, such as electronic health records and the like.

However, generation of messages in the HL7 format is not a straightforward task. Known techniques for generating these messages involve the use of expensive proprietary libraries and multiple complex function calls. These techniques are inefficient and fail to provide a flexible, robust way to generate healthcare messages. Through applied effort, ingenuity, and innovation, Applicant has solved many of these identified problems by developing a solution that is embodied by the present invention, which is described in detail below.

### BRIEF SUMMARY

A method, apparatus and computer program product are therefore provided according to an example embodiment of the present invention in order to provide for improved generation of healthcare messages. Embodiments may include a method. The method includes receiving a set of message script. The set of message script includes tokens defined within a message generation grammar. The message generation grammar defines a grammar for generating a standards-compliant message. The method further includes processing the set of message script, using a processor, wherein processing the set of message script comprises parsing and lexing the set of message script to map the tokens to select a set of message content, using the message generation grammar. The method also includes generating a markup representation of the set of message script comprising the selected set of message content, and generating the standards-compliant message using the markup representation. In some embodiments, the standards-compliant message is compliant with the Health Level 7 message standard. The set of message script may include at least one expression which, when processed, dynamically determines at least one content item for the standards-compliant message. In some embodiments, the method further includes receiving a message data object, and processing the expression to extract the at least one content item for the standards compliant message from the message data object. The set of message script may include a message header token indicating a presence of values for a message header, an event token indicating a presence of values for an event, and a patient identifier token indicating a presence of values for identifying a patient, and the values associated with the message header token, the event token, and the patient identifier token may be used to generate a corresponding message header field, event field, and patient identifier field of the standards-compliant message. In some embodiments, the method further includes providing the standards-compliant message to an application that provided the set of message script. The set of message script may define one or more repetition tokens indicating a value is repeated in the standards-compliant message. The markup representation may include one or more tags associated with one or more fields of the standards-compliant message, and the content of one or more fields of the standards-compliant message may be based at least in part on a corresponding tag of the markup representation.

Embodiments may also include an apparatus. The apparatus includes processing circuitry. The processing circuitry is be configured to cause the apparatus to receive a set of message script. The set of message script includes tokens defined within a message generation grammar. The message generation grammar defines a grammar for generating a standards-compliant message. The apparatus is further caused by the processing circuitry to process the set of message script. Processing the set of message script includes parsing and lexing the set of message script to map the tokens to select a set of message content, using the message generation grammar. The apparatus is also caused by the processing circuitry to generate a markup representation of the set of message script comprising the selected set of message content, and to generate the standards-compliant message using the markup representation. The standards-compliant message may be compliant with the Health Level 7 message standard. The set of message script may further include at least one expression which, when processed, dynamically determines at least one content item for the standards-compliant message. The apparatus may be further caused by the processing circuitry to receive a message data object, and to process the expression to extract the at least one content item for the standards compliant message from the message data object. The set of message script may include a message header token indicating a presence of values for a message header, an event token indicating a presence of values for an event, and a patient identifier token indicating a presence of values for identifying a patient, and the values associated with the message header token, the event token, and the patient identifier token may be used to generate a corresponding message header field, event field, and patient identifier field of the standards-compliant message. In some embodiments, the apparatus is further caused by the processing circuitry to provide the standards-compliant message to an application that provided the set of message script. The set of message script may define one or more repetition tokens indicating a value is repeated in the standards-compliant message. The markup representation may include one or more tags associated with one or more fields of the standards-compliant message, and the content of one or more fields of the standards-compliant message may be based at least in part on a corresponding tag of the markup representation.

Embodiments may further provide a computer program product including at least one computer-readable storage medium bearing computer program instructions embodied therein for use with a computer. The computer program instructions include program instructions configured to receive a set of message script. The set of message script includes tokens defined within a message generation grammar. The message generation grammar defines a grammar for generating a standards-compliant message. The computer program instructions further include program instructions configured to process the set of message script. Processing the set of message script includes parsing and lexing the set of message script to map the tokens to select a set of message content, using the message generation grammar. The computer program instructions further include program instructions configured to generate a markup representation of the set of message script comprising the selected set of message content, and program instructions configured to generate the standards-compliant message using the markup representation. The standards-compliant message may be compliant with the Health Level 7 message standard. The set of message script may include at least one expression which, when processed, dynamically determines at least one content item for the standards-compliant message. The computer program product may further include program instructions configured to receive a message data object, and to process the expression to extract the at least one content item for the standards compliant message from the message data object.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with example embodiments of the present invention;

FIG. 2 is a data flow diagram of an example data flow during a process for generating healthcare messages in accordance with example embodiments of the present invention;

FIG. 3 is a flow diagram of an example process for generating a healthcare message in accordance with example embodiments of the present invention; and

FIG. 4 is a flow diagram of an example process for extracting data from a message data object to determine information for inclusion in a healthcare message in accordance with embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### Introduction and Definitions

A method, apparatus and computer program product are provided in accordance with an example embodiment of the present invention in order to provide for improved generation of healthcare messages. In this regard, a method, apparatus and computer program product of an example embodiment may receive a set of message script. The message script may be processed to generate a markup language representation of the message. The markup language representation may be used to generate a message. Processing of the message script may include identifying one or more tokens within the message script, and extracting data from a message data object to provide content for the message.

### Example Apparatus

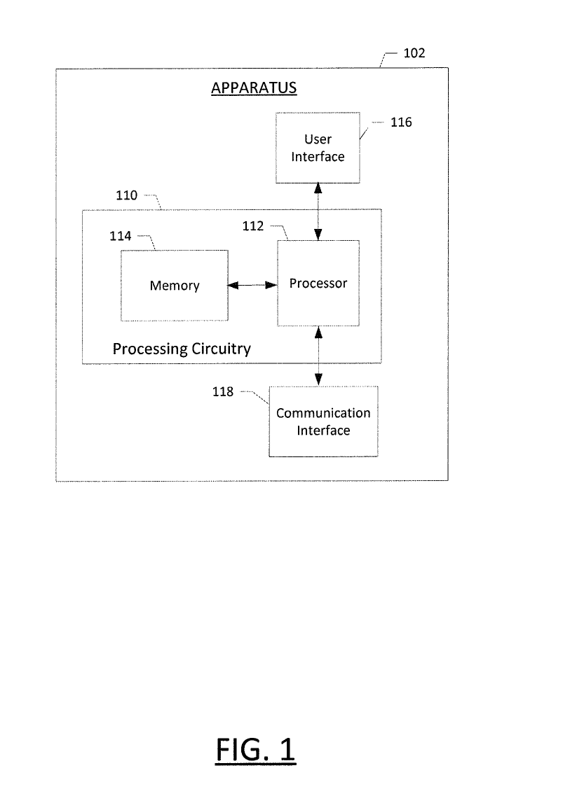

FIG. 1 illustrates a block diagram of an apparatus 102 in accordance with some example embodiments. The apparatus 102 may be any computing device capable generating healthcare messages as described herein. For example, the apparatus 102 may be implemented as a web server (standalone or rack-mounted), a desktop computer, a laptop computer, a tablet computer, a netbook computer, a mobile phone, a personal digital assistant, or the like. The apparatus 102 may be operable to generate a healthcare message by processing a set of message script. For example, the apparatus 102 may parse and lex the set of message script to identify one or more tokens within the script. Accordingly, it will be appreciated that the apparatus 102 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

The apparatus 102 may include or otherwise be in communication with processing circuitry 110 that is configurable to perform actions in accordance with one or more example embodiments disclosed herein. In this regard, the processing circuitry 110 may be configured to perform and/or control performance of one or more functionalities of the apparatus 102 (e.g., functionalities of a computing device on which the apparatus 102 may be implemented) in accordance with various example embodiments, and thus may provide means for performing functionalities of the apparatus 102 (e.g., functionalities of a computing device on which the apparatus 102 may be implemented) in accordance with various example embodiments. The processing circuitry 110 may be configured to perform data processing, application execution and/or other processing and management services according to one or more example embodiments. In some embodiments, the apparatus 102 or a portion(s) or component(s) thereof, such as the processing circuitry 110, may be embodied as or comprise a chip or chip set. In other words, the apparatus 102 or the processing circuitry 110 may comprise one or more physical packages (e.g., chips) including materials, components and/or wires on a structural assembly (e.g., a baseboard). The apparatus 102 or the processing circuitry 110 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 110 may include a processor 112 and, in some embodiments, such as that illustrated in FIG. 1, may further include memory 114. The processing circuitry 110 may be in communication with or otherwise control a user interface 116 and/or a communication interface 118. As such, the processing circuitry 110 may be embodied as a circuit chip (e.g., an integrated circuit chip) configured (e.g., with hardware, software or a combination of hardware and software) to perform operations described herein.

The processor 112 may be embodied in a number of different ways. For example, the processor 112 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 112 may comprise a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In some example embodiments, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry—in the form of processing circuitry 110) capable of performing operations according to embodiments of the present invention while configured accordingly. Thus, for example, when the processor 112 is embodied as an ASIC, FPGA or the like, the processor 112 may be specifically configured hardware for conducting the operations described herein. Alternatively, as another example, when the processor 112 is embodied as an executor of software instructions, the instructions may specifically configure the processor 112 to perform one or more operations described herein.

In some example embodiments, the memory 114 may include one or more non-transitory memory devices such as, for example, volatile and/or non-volatile memory that may be either fixed or removable. In this regard, the memory 114 may comprise a non-transitory computer-readable storage medium. It will be appreciated that while the memory 114 is illustrated as a single memory, the memory 114 may comprise a plurality of memories. The plurality of memories may be embodied on a single computing device or may be distributed across a plurality of computing devices collectively configured to function as the apparatus 102. The memory 114 may be configured to store information, data, applications, instructions and/or the like for enabling the apparatus 102 to carry out various functions in accordance with one or more example embodiments. For example, the memory 114 may be configured to buffer input data for processing by the processor 112. Additionally or alternatively, the memory 114 may be configured to store instructions for execution by the processor 112. As yet another alternative, the memory 114 may include one or more databases that may store a variety of files, contents or data sets. Among the contents of the memory 114, applications may be stored for execution by the processor 112 in order to carry out the functionality associated with each respective application. In some cases, the memory 114 may be in communication with one or more of the processor 112, user interface 116, or communication interface 118 via a bus or buses for passing information among components of the apparatus 102.

The user interface 116 may be in communication with the processing circuitry 110 to receive an indication of a user input at the user interface 116 and/or to provide an audible, visual, mechanical or other output to the user. As such, the user interface 116 may include, for example, a keyboard, a mouse, a joystick, a display, a touch screen display, a microphone, a speaker, a Light Emitting Diode (LED), a lighting device, and/or other input/output mechanisms.

The communication interface 118 may include one or more interface mechanisms for enabling communication with other devices and/or networks. In some cases, the communication interface 118 may be any means such as a device or circuitry embodied in either hardware, or a combination of hardware and software that is configured to receive and/or transmit data from/to a network and/or any other device or module in communication with the processing circuitry 110. By way of example, the communication interface 118 may be configured to enable the apparatus 102 to communicate with another computing device via a wireless network, such as a wireless local area network (WLAN), cellular network, and/or the like. Additionally or alternatively, the communication interface 118 may be configured to enable the apparatus 102 to communicate with another computing device via a wireline network. In some example embodiments, the communication interface 118 may be configured to enable communication between the apparatus 102 and one or more further computing devices via the internet. Accordingly, the communication interface 118 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

### Example Data Flow

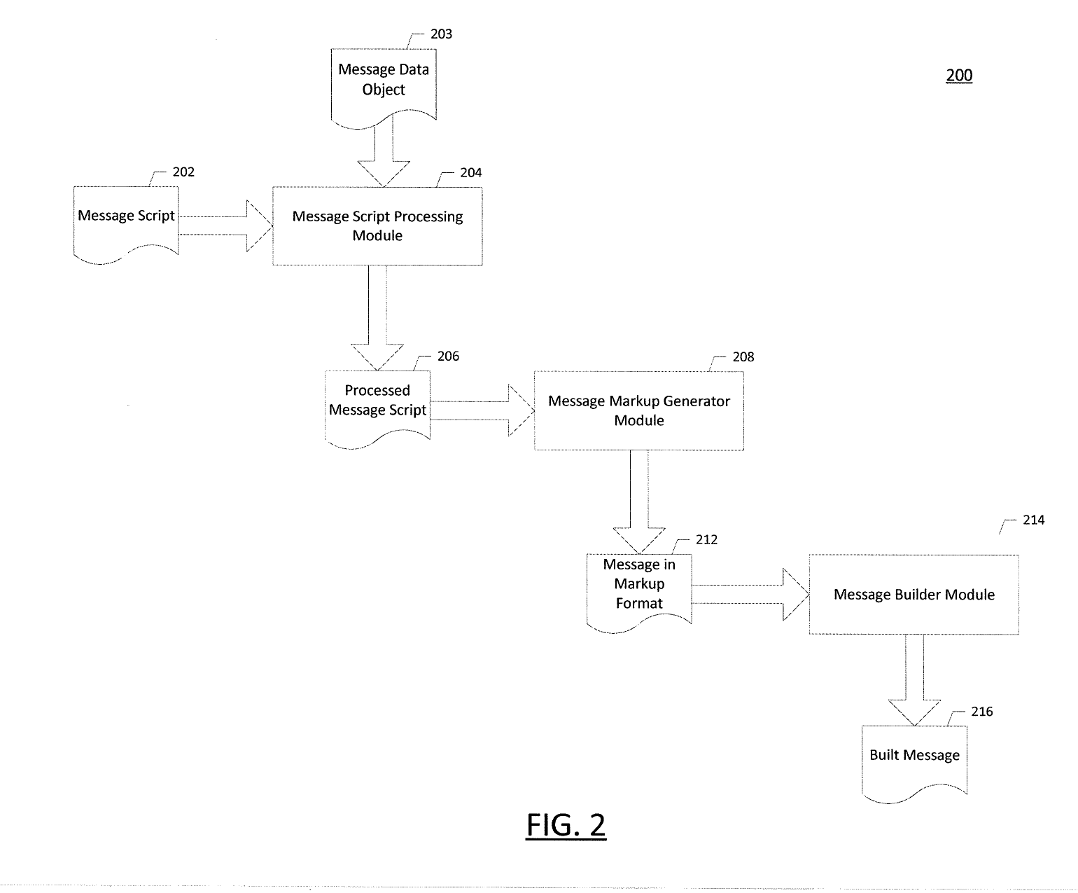

FIG. 2 is a data flow diagram of an example data flow 200 during a process for generating healthcare messages in accordance with example embodiments of the present invention. As described above, embodiments may facilitate the processing of a set of message script to generate a healthcare message. In a healthcare environment, different healthcare systems may communicate with one another according to particular messaging protocols, such as the HL7 message standard. For example, an electronic health record (EHR) system may communicate with a picture archiving and communication system (PACS) to obtain or store patient radiological images, or a first EHR system may synchronize records with a second EHR system, or a hospital admission and discharge system may store patient medical records in an EHR system. In order to enable this intersystem communication, messages in the particular standard used by each of the systems must be generated. Embodiments facilitate the generation of these messages by providing flexible, robust techniques for defining message structures that are compliant with the particular standards being used by the system.

The data flow 200 begins with a set of message script 202. The message script 202 may include a representation of the message as a series of text values which are provided according to a predefined message grammar. For example, a message header for the message may be indicated through the use of the text “MSH”, and the text “ADT” may indicate that the message is of an “Admit/Discharge/Transfer” type if presented in a field associated with the message type. It should be appreciated that various grammars, definitions, and tokens could be used to define the structure of the message, and while the instant examples provided are primarily directed to HL7 messages, such techniques could also be readily modified to function with other standards and/or different types of messages.

The following is an example of a simple message written as a set of message script, with comments describing the tokens after the “//” symbols:

TABLE 1

```
MSH //Message Header Structure{
      3:‘SIGNUM’, // sending application
      4:‘DEMO’, // sending facility
      5:‘TRAK’, // receiving application
      6:‘MPV’, // receiving facility
      7:‘${now}’, // date/time of message
      9: { // message type
      1:‘ADT’, // adt
      2:‘A101’ // message type
      },
      10:‘AWX123’, // msg control id
      11:‘P’, // processing id
      12:‘2.2’, // version id
      18:‘UTF-8’ // character set
      }
EVN //Event Structure{
      1:‘A01’, // event type code
      2:‘${now}’, // recorded date/time
      5:‘BPS’ // patient initials
      }
PID //Patient Identifier Structure{
      1:‘1’, // set Id - PID
    3 -> { // patient identifier list
        [
          1:‘1234567890’, // patient mrn
          4:‘ST01A’, // assigning authority
          5:‘MR’ // identifier type code
        ],
        [
          1:‘0987654321’, // patient mrn
          4:‘TR10B’, // assigning authority
        5:‘AC’ // identifier type code
        ]
      }
      },
      5: { // patient name
      1:‘DOE’, // patient last name
      2:‘JOHN’ // patient first name
      },
      7: ‘19660812’, // patient dob
      8: ‘M’, // patient sex
      10: ‘C’, // patient race
      16: ‘S’, // maritial status
      18: ‘987654321’ // registration number
      }
```

This example set of message script illustrates how portions of the message (e.g., the header, an event, and a patient identifier) may be defined using text tokens. It should be appreciated that the numerals before colons refer to particular fields of a particular structure (e.g., of the message header, event, or patient identifier, or to corresponding sub structures). Repetitions may be indicated using the “->” arrow indicator. So from the example above, starting at PID.3, instead of using a colon, an arrow is used to represent a ‘repetition’. Repetitions may be presented within brackets and repeat themselves using different values for each iteration of the repetition. For example, in the present case, the patient identifier list would include two repetitions in the PID.3 structure for the two patient records in the patient identifier list. It should also be appreciated that values may not be “hard coded”, and that the message script may additionally or alternatively employ the use of tokens that trigger queries against a datastore when processed. For example, the following message script includes the use of such queries:

TABLE 2

```
use patient
MSH {
      3:‘${env.sendingapp}’, // sending application
      4:‘${env.sendfacility}’, // sending facility
      5:‘${env.recvapp}’, // receiving application
      6:‘${env.revcfacility}’, // receiving facility
      7:‘${now}’, // date/time of message
      9: { // message type
            1:‘${env.msgclass}’, // adt
            2:‘${env.msgtype}’ // message type
      },
      10:‘${env.controlid}’, // msg control id
      11:‘${env.processid}’, // processing id
      12:‘2.2’, // version id
      18:‘UTF-8’ // character set
      }
EVN {
      1:‘${env.msgtype}’, // event type code
      2:‘${now}’, // recorded date/time
      5:‘${patient.initials}’ // patient initials
      }
PID {
      1:‘1’, // set Id - PID
      3 -> { // patient identifier list
      [
      1:‘${patient.mrn}’, // patient mrn
            4:‘ST01A’, // assigning authority
            5:‘MR’ // identifier type code
      ]
            },
      5: { // patient name
            1:‘${patient.lastname}’, // patient last name
            2:‘${patient.firstname}’ // patient first name
      },
      7: ‘${now}’, // patient dob
      8: ‘${patient.sex}’, // patient sex
      10: ‘${patient.race}’, //patient race
      16: ‘${patient.maritialstatus}’, // maritial status
      18: ‘${patient.regnum}’ // registration number
}
```

In the example illustrated in Table 2, expressions denoted by the “$” symbol may be used to perform value lookups. For example, these expressions may be interpreted by a message script processing module 204 along with a message data object 203 supplied with the set of message script 202. For example, an application creating a message may generate a message data object 203 and set of message script 202 and provide both to the message script processing module 204 via an API call. In some embodiments, the message data object 203 is provided as a “Java Bean” data structure that can be queried by the expressions defined in the set of message script. For example, the set of message script 202 and the message data object 203 may be provided to the message script processing module 204 via an API function call that provides both structures as arguments. In the example above, the expression token “$” references a data object with the name “env”, and various data values contained therein, such as a message class and process identifier. Similarly, a data object named “patient” includes identifiers for the patient first name, last name, registration number, and the like. Although the instant example includes multiple data objects, it should be appreciated that a single data object could be passed with the set of message script for processing, or a plurality of data objects could be passed. Upon execution of the API call, both structures may be passed to the message script processing module 204 for generation of a message. The following is an example data structure that may be passed to the message script processing module 204:

A “java bean” is simply a class with a getter and setter method. For example, here is a really simple java bean:

TABLE 3

```
class Person {
      int age;
      String name;
      public int getAge( ) {
      return age;
      }
      public void setAge(int age) {
      this.age = age;
      }
      public String getName( ) {
      return name;
      }
      public void setName(String name) {
      this.name = name;
      }
      }
```

The use of expressions in this manner allows for the set of message script 202 to define one or more templates which are populated by data contained within the message data object 203. For example, the same set of message script could be utilized to generate multiple messages, each for a different patient defined within the message data object, by using expressions to populate the relevant sections of the message from the message data object.

In some embodiments, the message data object 203 may further include various identifiers to facilitate the extraction of data from the message data object for inclusion in the message. For example, the message data object 203 may be associated with a “name” or elements within the message data object 203 may have different names. In some embodiments, these identifiers are provided in a function call containing the set of message script and the message data object to facilitate selection of content for created messages.

The message script processing module 204 may parse and/or lex the message script 202 against a predefined grammar included within the message script processing module 204 to generate a processed message script 206. The predefined grammar may be associated with a particular message standard such as, for example, one or more of the Health Level 7 Messaging Standards put forth by the HL7 International standards organization, such as HL7 Version 1, HL7 Version 2, HL7 Version 3, updated releases thereof, or the like. The standard associated with the predefined grammar may thus be associated with and define the standard for an output standard-compliant message. For example, in some embodiments the message script processing module 204 is created by providing a grammar file to a compiler compiler, such as Yet Another Compiler Compiler (YACC) or Another Tool for Language Recognition (ANTLR). The compiler compiler may generate the message script processing module 204 by providing a framework to lex and parse the grammar provided as input to the compiler compiler. The predefined grammar may define mappings between the text tokens contained within the message script grammar to particular functions, processes, and/or data queries to extract data from the message data object. For example, the message data object 203 may include information extracted from a set of patient electronic health records.

As described above, the message markup generator module 208 may receive the processed set of message script 206 and generate markup formatted message script 212 corresponding to the message constructed by execution of the functions, processes, and/or queries contained within the processed set of message script 206. The resulting output may, for example, be as an HL7 message structure encoded in a markup language such as Extensible Markup Language (XML). An example XML output of the above example given with respect to Table 2, after execution of the functions, processes, and/or queries related to the expressions, might be as follows:

TABLE 3

```
  <?xml version=“1.0” encoding=“UTF-8” ?>
<HL7>
    <MESSAGE>
    <MSH fieldSeparator=“|” componentSeparator=“\hat{ }”
    repetitionSeparator=“~” escapeCharacter=“\”
    subcomponentSeparator=“&”
    numFields=“18”>
      <MSH.1 />
      <MSH.2 />
      <MSH.3>SIGNUM</MSH.3>
      <MSH.4>DEMO</MSH.4>
      <MSH.5>TRAK</MSH.5>
      <MSH.6>MPV</MSH.6>
      <MSH.7>20140225110732.691-0600</MSH.7>
      <MSH.8 />
        <MSH.9 numComponents=“2”>
          <MSH.9.1>ADT</MSH.9.1>
          <MSH.9.2>A01</MSH.9.2>
          </MSH.9>
        <MSH.10>AWX123</MSH.10>
      <MSH.11>P</MSH.11>
      <MSH.12>2.2</MSH.12>
      <MSH.13 />
      <MSH.14 />
      <MSH.15 />
      <MSH.16 />
      <MSH.17 />
      <MSH.18>UTF-8</MSH.18>
      </MSH>
    <EVN numFields=“5”>
      <EVN.1>A01</EVN.1>
      <EVN.2>20140225110732.691-0600</EVN.2>
      <EVN.3 />
      <EVN.4 />
      <EVN.5>BPS</EVN.5>
    </EVN>
  <PID numFields=“18”>
      <PID.1>1</PID.1>
      <PID.2 />
<PID.3 numRepetitions=“2”>
      <PID.3 numComponents=“3”>
          <PID.3.1>1234567890</PID.3.1>
          <PID.3.4>ST01A</PID.3.4>
          <PID.3.5>MR</PID.3.5>
      </PID.3>
      <PID.3 numComponents=“3”>
          <PID.3.1>0987654321</PID.3.1>
          <PID.3.4>TR10B</PID.3.4>
          <PID.3.5>AC</PID.3.5>
      </PID.3>
</PID.3>
      <PID.4 />
        <PID.5 numComponents=“2”>
          <PID.5.1>DOE</PID.5.1>
          <PID.5.2>JOHN</PID.5.2>
      </PID.5>
      <PID.6 />
      <PID.7>19660812</PID.7>
      <PID.8>M</PID.8>
      <PID.9 />
      <PID.10>C</PID.10>
      <PID.11 />
      <PID.12 />
      <PID.13 />
      <PID.14 />
      <PID.15 />
      <PID.16>S</PID.16>
      <PID.17 />
      <PID.18>987654321</PID.18>
        </PID>
    </MESSAGE>
  </HL7>
```

The message script in markup format 212 may be processed by a message builder module 214 to generate a built message 216. The message builder module 214 may receive the message script in markup format 212 and define the parameters for an outgoing message based on the presence or absence of particular tags in the markup language. For example, an example built message corresponding to the examples of Tables 2 and 3 might take the following format as an HL7 message:

TABLE 4

MSH|\hat{ }~\&|SIGNUM|DEMO|TRAK|MPV|20140225110906.707-
0600||ADT\hat{ }A01|AWX123|P|2.2||||||UTF-8
EVN|A01|20140225110906.707-0600|||BPS
PID|1||1234567890\hat{ }\hat{ }||DOE\hat{ }JOHN||19660812|M||C||||||S||987654321

The built message 216 is created by the message builder module 214 in a format that is compliant with the messaging standard being utilized and suitable for transmission to the destination. This built message may include a plurality of content items. These content items may include particular structures within the message, including but not limited to identifiers for fields within the message, a type of the message, information about a patient referenced by the message, or any other structure or content of the message. In this manner, completion of the data flow 200 results in the use of a flexible, robust, straightforward message script being used to generate an output message that is fully standards-compliant and suitable for transmission.

### Example Message Generation Processes

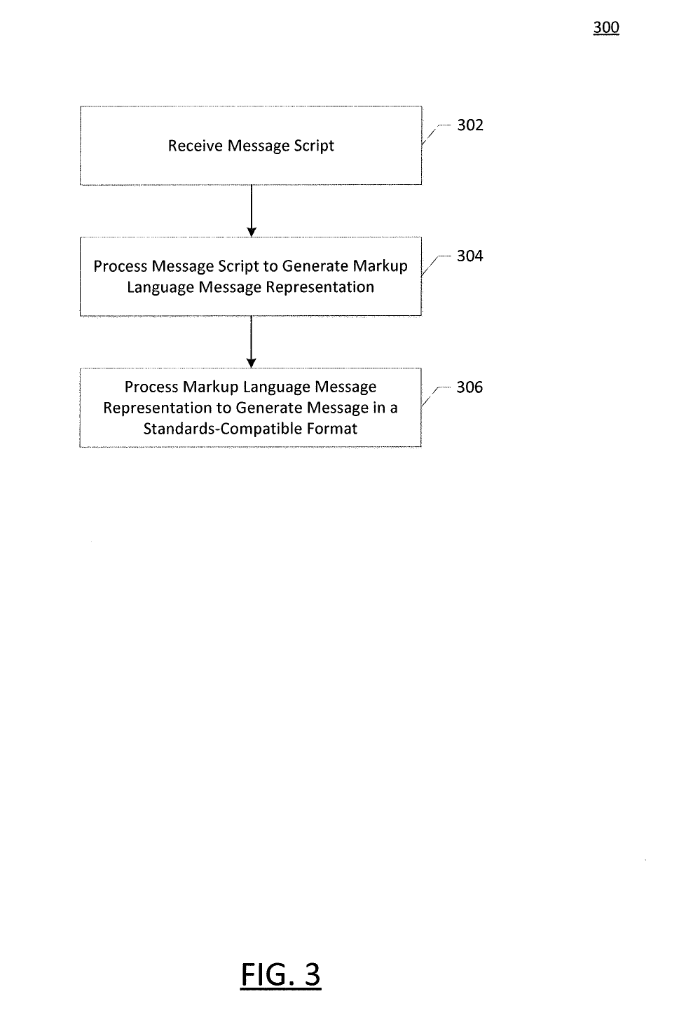

FIG. 3 is a flow diagram of an example process 300 for generating a message from a set of message script in accordance with embodiments of the present invention. In some embodiments, the process 300 may be performed by an apparatus, such as the apparatus 102 described above with respect to FIG. 1. To that end, the apparatus 102 may include a message script processing module 204, a message markup generator module 208, and/or a message builder module 214 to perform one or more of the elements of the process 300. As described above, the process 300 may generate a message by processing a set of message script to generate a markup representation of the message script. The markup representation may be processed to generate a message in a standards-compatible format.

At action 302, a set of message script is received. As described above, the set of message script may be a data file, data files, or a portion of a data file that includes tokens (e.g., characters and/or text) that define the structure of a message in a script format (see, e.g., Tables 1 and 2 above). The process 300 may receive the set of message script from a variety of sources, such as an application wishing to transmit a message in a particular format (e.g., HL7). In this manner, the process 300 may function as an intermediary for the application, such that the process 300 handles generating and transmitting the message according to the set of message script provided by the application. Alternatively, in some embodiments, the process 300 may merely generate the message, and provide the generated message back to the application that provided the set of message script so the application can take a variety of actions with respect to the generated message (e.g., storing for later use, transmitting, transmitting with other similar messages, modifying one or more fields of the generated message, or the like).

At action 304, a markup representation of the set of message script is generated. As described above, the markup representation (see, e.g., Table 3), of the message may be generated by mapping particular text tokens from within the set of message script to tags of a markup language. As described above, in some embodiments the values of the tags of the markup language may be determined based on one or more queries against a datastore, such that the markup language is populated with the results of the queries. As with the example above, in some embodiments the markup language is XML, with tags that correspond to elements of an HL7 message.

At action 306, the markup representation of the set of message script is used to generate the final message in the standards-compliant format. For example, the markup representation may be processed such that particular tags of the markup language are mapped to particular predefined fields of the generated message. The generated message may be transmitted by the process 400 or, alternatively or additionally, be provided back to the application that provided the set of message script for use by the application as needed.

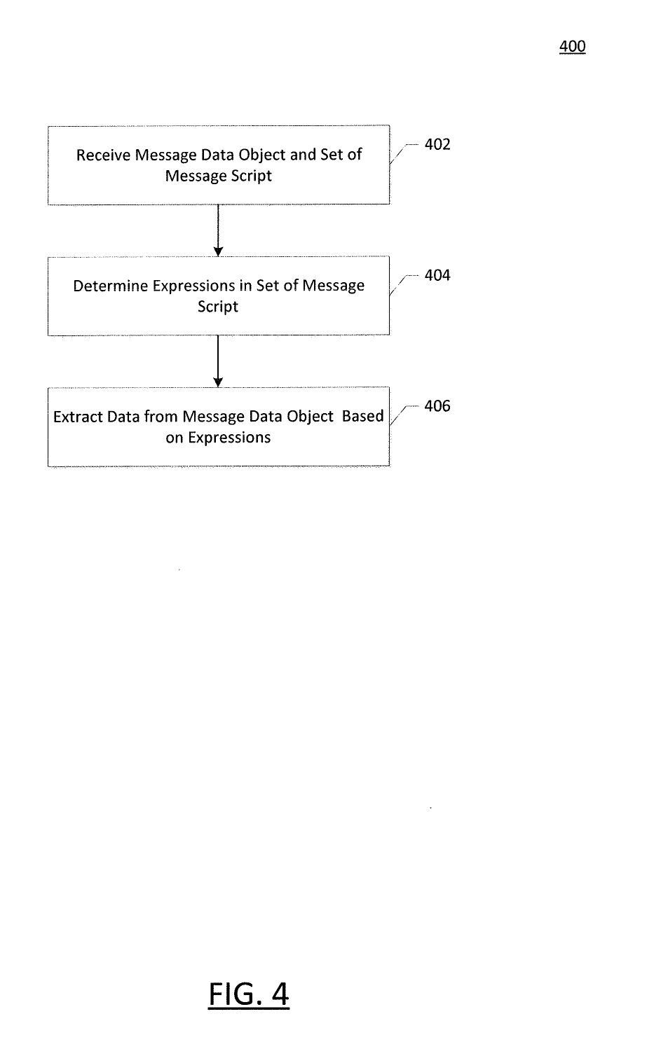

FIG. 4 is a flow diagram of an example process 400 for populating a message generated using a set of message script and a message data object in accordance with embodiments of the present invention. In some embodiments, the process 400 may be performed by an apparatus, such as the apparatus 102 described above with respect to FIG. 1. To that end, the apparatus 102 may include a message script processing module 204, a message markup generator module 208, and/or a message builder module 214 to perform one or more of the elements of the process 400. The process 400 may function to take a particular action, such as obtaining additional data from a message data object, based on the presence of particular tokens in a set of message script. In this manner, messages may be defined in a flexible format that allows for the use of message templates, rather than hard-coding of outgoing message data. Tokens within the message script may be mapped to particular functions or queries, such that when a particular token is processed, a particular function call or query is added to a set of processed message data to be executed against a message data object. As described above, the message data object may include message information as provided by a calling application. This information may be obtained by the calling application in a variety of manners, including but not limited to obtaining data from an electronic health records datastore. The processed message data may be utilized to generate a markup representation of the message which, as described above with respect to FIG. 3, may be employed to generate the standards-compliant message.

At action 402, a message data object and a set of message script are received. As described above, the set of message script may include a set of tokens defined using a grammar for the message script language. At action 404, expressions are identified within the set of message script based on the presence of particular tokens (e.g., the use of the “$” token along with values identifying a particular data item from the message data object).

At action 406, data is extracted from the message data object in accordance with the identified expressions. At action 408, the extracted data is included in a set of message markup language for use in generating a message as described above with respect to FIG. 3.

It will be understood that each element of the flowcharts, and combinations of elements in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 114 of an apparatus employing an embodiment of the present invention and executed by a processor 112 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a set of message script, the set of message script comprising tokens defined within a message generation grammar, the message generation grammar defining a grammar for generating a standards-compliant message;
processing the set of message script, using a processor, wherein processing the set of message script comprises parsing and lexing the set of message script to map the tokens to select a set of message content, using the message generation grammar;
generating a markup representation of the set of message script comprising the selected set of message content; and
generating the standards-compliant message using the markup representation.

2. The method of claim 1, wherein the standards-compliant message is compliant with the Health Level 7 message standard.

3. The method of claim 1, wherein the set of message script further comprises at least one expression which, when processed, dynamically determines at least one content item for the standards-compliant message.

4. The method of claim 3, further comprising:
receiving a message data object; and
processing the expression to extract the at least one content item for the standards compliant message from the message data object.

5. The method of claim 1, wherein the set of message script comprises a message header token indicating a presence of values for a message header, an event token indicating a presence of values for an event, and a patient identifier token indicating a presence of values for identifying a patient, and wherein the values associated with the message header token, the event token, and the patient identifier token are used to generate a corresponding message header field, event field, and patient identifier field of the standards-compliant message.

6. The method of claim 1, further comprising providing the standards-compliant message to an application that provided the set of message script.

7. The method of claim 1, wherein the set of message script defines one or more repetition tokens indicating a value is repeated in the standards-compliant message.

8. The method of claim 1, wherein the markup representation comprises one or more tags associated with one or more fields of the standards-compliant message, and wherein the content of one or more fields of the standards-compliant message is based at least in part on a corresponding tag of the markup representation.

9. An apparatus comprising processing circuitry configured to cause the apparatus to:
receive a set of message script, the set of message script comprising tokens defined within a message generation grammar, the message generation grammar defining a grammar for generating a standards-compliant message;
process the set of message script, wherein processing the set of message script comprises parsing and lexing the set of message script to map the tokens to select a set of message content, using the message generation grammar;
generate a markup representation of the set of message script comprising the selected set of message content; and
generate the standards-compliant message using the markup representation.

10. The apparatus of claim 9, wherein the standards-compliant message is compliant with the Health Level 7 message standard.

11. The apparatus of claim 9, wherein the set of message script further comprises at least one expression which, when processed, dynamically determines at least one content item for the standards-compliant message.

12. The apparatus of claim 11, further caused to:
receive a message data object; and
process the expression to extract the at least one content item for the standards compliant message from the message data object.

13. The apparatus of claim 9, wherein the set of message script comprises a message header token indicating a presence of values for a message header, an event token indicating a presence of values for an event, and a patient identifier token indicating a presence of values for identifying a patient, and wherein the values associated with the message header token, the event token, and the patient identifier token are used to generate a corresponding message header field, event field, and patient identifier field of the standards-compliant message.

14. The apparatus of claim 9, further caused to provide the standards-compliant message to an application that provided the set of message script.

15. The apparatus of claim 9, wherein the set of message script defines one or more repetition tokens indicating a value is repeated in the standards-compliant message.

16. The apparatus of claim 9, wherein the markup representation comprises one or more tags associated with one or more fields of the standards-compliant message, and wherein the content of one or more fields of the standards-compliant message is based at least in part on a corresponding tag of the markup representation.

17. A computer program product comprising at least one computer-readable storage medium bearing computer program instructions embodied therein for use with a computer, the computer program instructions comprising program instructions configured to:
receive a set of message script, the set of message script comprising tokens defined within a message generation grammar, the message generation grammar defining a grammar for generating a standards-compliant message;
process the set of message script, wherein processing the set of message script comprises parsing and lexing the set of message script to map the tokens to select a set of message content, using the message generation grammar;
generate a markup representation of the set of message script comprising the selected set of message content; and
generate the standards-compliant message using the markup representation.

18. The computer program product of claim 17, wherein the standards-compliant message is compliant with the Health Level 7 message standard.

19. The computer program product of claim 17, wherein the set of message script further comprises at least one expression which, when processed, dynamically determines at least one content item for the standards-compliant message.

20. The computer program product of claim 19, further comprising program instructions configured to:
receive a message data object; and
process the expression to extract the at least one content item for the standards compliant message from the message data object.
